(19) United States
(12) Patent Application Publication
(10) Pub. No.: US 2014/0223039 A1
(43) Pub. Date: Aug. 7, 2014

(54) HARD DISK BOARD AND SERVER SYSTEM USING SAME

(71) Applicants: HON HAI PRECISION INDUSTRY CO., LTD., New Taipei (TW); HONG FU JIN PRECISION INDUSTRY (ShenZhen) CO., LTD ., Shenzhen (CN)

(72) Inventors: KANG WU, Shenzhen (CN); LEI DENG, Shenzhen (CN)

(73) Assignees: HON HAI PRECISION INDUSTRY CO., LTD., New Taipei (TW); HONG FU JIN PRECISION INDUSTRY (ShenZhen) CO., LTD ., Shenzhen (CN)

(21) Appl. No.: 14/067,921

(22) Filed: Oct. 30, 2013

(30) Foreign Application Priority Data
Feb. 4, 2013 (CN) 2013100425261

(51) Int. Cl. G06F 3/06

(52) U.S. Cl. CPC G06F 3/0653; G06F 3/0604; G06F 3/0689
USPC 710/19

(57) ABSTRACT

An exemplary server system includes at least one motherboard, a plurality of hard disks, and a hard disk board connected the hard disks to the at least one motherboard. The hard disk board includes a plurality of indicators indicating a status of each of the hard disks, a first connector connected to the indicators, and a second connector connected to part of the indicators.

### BACKGROUND

1. Technical Field

The present disclosure relates to a hard disk board and a server system using the hard disk board.

2. Description of Related Art

Light emitting diodes (LEDs) are employed on a hard disk board of a server system to provide a visual notification of a status of each hard disk of the server system. When the hard disks are operating normally, motherboards of the server system control the LEDs to be unlit. In contrast, when a hard disk of a motherboard malfunctions, an LED corresponding to the malfunctioned hard disk lights.

However, different server systems may include different numbers of the motherboards, or even though the different servers systems include same numbers of the motherboards, placement relations between the motherboards may be different. As a result, each of the different server systems may require a different hard disk board to interconnect motherboards and hard disks. Accordingly, costs of the server systems are high.

Therefore, what is needed is an item that can overcome the described limitations.

### BRIEF DESCRIPTION OF THE DRAWINGS

FIG. 1 is a schematic structural diagram illustrating one embodiment of a first server system according to the present disclosure.

FIG. 2 is a schematic structural diagram illustrating one embodiment of a second server system according to the present disclosure.

### DETAILED DESCRIPTION

Reference will now be made to the drawings to describe specific exemplary embodiments of the present disclosure.

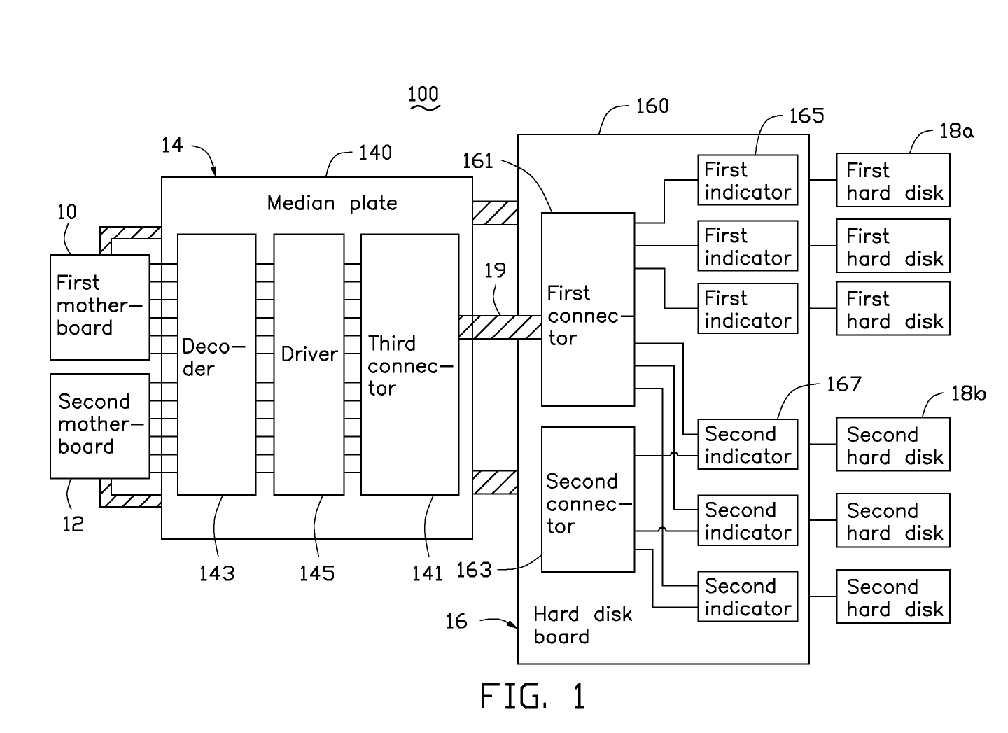

FIG. 1 is a schematic structural diagram illustrating one embodiment of a first server system 100 according to the present disclosure. The first server system 100 includes a first motherboard 10, a second motherboard 12, a median plate 14, a hard disk board 16, three first hard disks 18a, three second hard disks 18b, and a cable 19. The first motherboard 10 is connected to the three first hard disks 18a via the median plate 14 and the hard disk board 16 in series. The second motherboard 12 is connected to the three second hard disks 18b via the median plate 14 and the hard disk board 16 in series. The first, second motherboards 10, 12, and the median plate 14 are positioned on a same layer of a rack (not shown) that holds the server system 100. In the embodiment, the first hard disks 18a may be identical to the second hard disks 18b, for example. The first motherboard 10 may be identical to the second motherboard 12, for example.

The hard disk board 16 includes a base plate 160, a first connector 161, a second connector 163, three first indicators 165, and three second indicators 167. The first connector 161, the second connector 163, the three first indicators 165, and the three second indicators 167 are positioned on the base plate 160. Each of the three first indicators 165 is directly opposite to a corresponding first hard disk 18a, and is configured to indicate a status of the opposite first hard disk 18a. Each of the three second indicators 167 is directly opposite to a corresponding second hard disk 18b, and is configured to indicate a status of the opposite second hard disk 18b. The first, second indicators 165, 167 may be light emitting diodes (LEDs), for example. The first connector 161 is connected to the first, second indicators 165, 167. The second connector 163 is connected to the second indicators 167. In the present embodiment, when the first server system 100 is powered on, the first connector 161 is electrically connected to the first, second indicators 165, 167. The second connector 163 is unused. The first indicators 165 may be identical to the second indicators 167, for example.

The median plate 14 includes a base plate 140, a third connector 141, a decoder 143, and a driver 145. The third connector 141, the decoder 143, and the driver 145 are positioned on the base plate 140. The third connector 141 is connected to the first connector 161 via the cable 19. The third connector 141 is further connected to the first, second motherboards 10, 12 via the driver 145 and the decoder 143 in sequence.

The first motherboard 10 determines the status of each of the first hard disks 18a and controls whether each of the first indicators 165 is in a first indicating state or a second indicating state based on a first determination. The second motherboard 12 determines the status of each of the second hard disks 18b and controls whether each of the second indicators 167 is in the first indicating state or the second indicating state based on a second determination. The first indicating state differs from the second indicating state. In the embodiment, an unlit state is defined as the first indicating state. A light state is defined as the second indicating state. In addition, the first indicating state represents that a hard disk 18a/18b is operating normally. The second indicating state represents that a hard disk 18a/18b malfunctions.

Take a first hard disk 18a as an example, when the first motherboard 10 determines that the first hard disk 18a malfunctions, the first motherboard 10 outputs a first control signal to the decoder 143. The decoder 143 receives the first control signal from the first motherboard 10, decodes the first control signal, and outputs the decoded first control signal to the driver 145. The driver 145 receives the decoded first control signal, amplifies the decoded first control signal, and outputs the amplified first control signal to the first indicator 165 directly opposite to the first hard disk 18a that malfunctions via the third connector 141 and the first connector 161. The first indicator 165 directly opposite to the first hard disk 18a that malfunctions receives the amplified first control signal, and enters in the second indicating state based on the amplified first control signal to notify a user that the first hard disk 18a directly opposite to the first indicator 165 malfunctions in the second state.

Similar to the above first hard disk 18a, when the second motherboard 12 determines that a second hard disk 18b malfunctions, the second motherboard 12 outputs a second control signal to the decoder 143. The decoder 143 receives the second control signal from the second motherboard 12, decodes the second control signal, and outputs the decoded second control signal to the driver 145. The driver 145 receives the decoded second control signal, amplifies the decoded second control signal, and outputs the amplified second control signal to the second indicator 167 directly opposite to the second hard disk 18b that malfunctions via the third connector 141 and the first connector 161. The second indicator 167 directly opposite to the second hard disk 18b that malfunctions receives the amplified second control signal, and enters the second indicating state based on the amplified second control signal. The second control signal may be identical to the first control signal, for example.

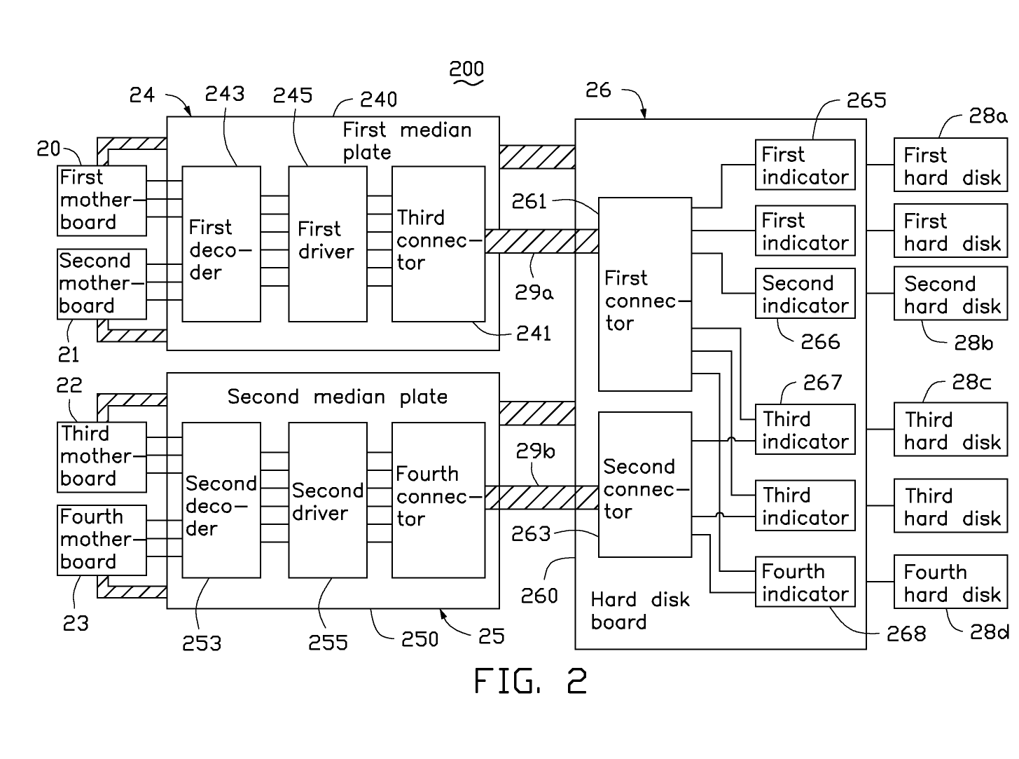

FIG. 2 is a schematic structural diagram illustrating one embodiment of a second server system 200 according to the present disclosure. The second server system 200 includes a first motherboard 20, a second motherboard 21, a third motherboard 22, a fourth motherboard 23, a first median plate 24, a second median plate 25, a hard disk board 26, two first hard disks 28a, a second hard disk 28b, two third hard disks 28c, a fourth hard disk 28d, a first cable 29a, and a second cable 29b.

The first motherboard 20 is connected to the two first hard disks 28a via the first median plate 24 and the hard disk board 26 in sequence. The second motherboard 21 is connected to the second hard disk 28b via the first median plate 24 and the hard disk board 26 in sequence. The third motherboard 22 is connected to the two third hard disks 28c via the second median plate 25 and the hard disk board 26 in sequence. The fourth motherboard 23 is connected to the fourth hard disk 28d via the second median plate 25 and the hard disk board 26 in sequence. In the embodiment, the first, second motherboards 20, 21, and the first median plate 24 are positioned on a same layer of a rack (not shown) that holds the server system 200. The third, fourth motherboards 22, 23, and the second median plate 25 are positioned on another same layer of the rack that holds the server system 200. In the embodiment, the first, second, third, and fourth motherboards 20, 21, 22, 23 may be identical to one another, for example. The first median plate 24 and the second median plate 25 may be identical to each other, for example. The first, second, third, and fourth hard disks 28a, 28b, 28c, 28d may be identical to one another, for example.

The hard disk board 26 includes a base plate 260, a first connector 261, a second connector 263, two first indicators 265, a second indicator 266, two third indicators 267, and a fourth indicator 268. The first connector 261, the second connector 263, the two first indicators 265, the second indicator 266, the two third indicators 267, and the fourth indicator 268 are positioned on the base plate 260. The first connector 261 is connected to the two first indicators 265, the second indicator 266, the two third indicators 267, and the fourth indicator 268. The first connector 261 is further connected to the first, second motherboards 20, 21 via the first median plate 24. The second connector 263 is connected to the two third indicators 267 and the fourth indicator 268. The second connector 263 is further connected to the third, fourth motherboards 22, 23 via the second median plate 25. The two first indicators 265 are directly opposite to the two first hard disks 28a one by one. The second indicator 266 is directly opposite to the second hard disk 28b one by one. The two third indicators 267 are directly opposite to the two third hard disks 28c one by one. The fourth indicator 268 is directly opposite to the fourth hard disk 28d one by one.

The second hard disk board 26 is identical to the hard disk board 16 of the first server system 100. That is, the first connector 261 is identical to the first connector 161. The second connector 263 is identical to the second connector 261. The two first indicators 265 and the second indicator 266 are identical to the three first indicators 165. The two third indicators 267 and the fourth indicator 268 are identical to the three second indicators 167. When the second server system 200 is powered on, the first connector 261 is electrically connected to the two first indicators 265 and the second indicator 266. The second connector 263 is electrically connected to the two third indicators 267 and the fourth indicator 268. In the embodiment, when the second server system 200 is powered on, the first connector 261 is not electrically connected to the two third indicators 267 and the fourth indicator 268.

The first median plate 24 includes a first base plate 240, a third connector 241, a first decoder 243, and a first driver 245. The third connector 241, the first decoder 243, and the first driver 245 are positioned on the first base plate 240. The third connector 241 is connected to the first connector 261 via the first cable 29a. The third connector 241 is further connected to the first, second motherboards 20, 21 via the first driver 245 and the first decoder 243 in sequence.

The second median plate 25 includes a second base plate 250, a fourth connector 251, a second decoder 253, and a second driver 255. The fourth connector 251, the second decoder 253, and the second driver 255 are positioned on the second base plate 250. The fourth connector 251 is connected to the second connector 263 via the second cable 29b. The fourth connector 251 is further connected to the third, fourth motherboards 22, 23 via the second driver 255, and the second decoder 253 in sequence.

The first motherboard 20 determines the status of each of the first hard disks 28a and controls whether each of the first indicators 265 is in the first indicating state or the second indicating state based on a first determination. The second motherboard 21 determines the status of each of the second hard disks 28b and controls whether each of the second indicators 266 is in the first indicating state or the second indicating state based on a second determination. The third motherboard 22 determines the status of each of the third hard disks 28c and controls whether each of the third indicators 267 is in the first indicating state or the second indicating state based on a third determination. The fourth motherboard 23 determines the status of each of the fourth hard disks 28d and controls whether each of the fourth indicators 268 is in the first indicating state or the second indicating state based on a fourth determination.

Take the fourth hard disk 28d as an example, when the fourth motherboard 23 determines that the fourth hard disk 28d malfunctions, the fourth motherboard 23 outputs a control signal to the second decoder 253. The second decoder 253 receives the control signal from the fourth motherboard 23, decodes the control signal, and outputs the decoded control signal to the second driver 255. The second driver 255 receives the decoded control signal, amplifies the decoded control signal, and outputs the amplified control signal to the fourth indicator 268 directly opposite to the fourth hard disk 28d that malfunctions via the fourth connector 251 and the second connector 263. The fourth indicator 268 directly opposite to the fourth hard disk 28d that malfunctions receives the amplified control signal, and enters in the second indicating state based on the amplified control signal.

Similar to the above fourth hard disk 28d, the status of each of the first hard disks 28a, the second hard disks 28b, and the third hard disks 28c can be determined by the first, second, and third motherboards 20, 21, 22, respectively. Accordingly, the first, second, and third motherboards 20, 21, 22 control whether the first, second, and third indicators 265, 266, 267 are in the first indicating state or the second indicating state, respectively. Operation of the second server system 200 is not described in detail here.

As described above, since the hard disk board 26 and the hard disk board 16 are identical to each other, the hard disk board 26/16 also can be employed in the second server system 200. That is, the different first, second server systems 100, 200 can use the same hard disk board 26/16. As a result, the costs of the different first, second server systems 100, 200 are low.

In alternative embodiments, the number of motherboards of the server system 200 (100) may be three, five, or more. The number of connectors of the hard disk board 26 (16) may be three, five, or more.

It is believed that the present embodiments and their advantages will be understood from the foregoing description, and it will be apparent that various changes may be made thereto without departing from the spirit and scope of the present disclosure or sacrificing all of its material advantages, the examples hereinbefore described merely being preferred or exemplary embodiments.

What is claimed is:

1. A hard disk board configured to connect at least one motherboard to a plurality of hard disks, the hard disk board comprising:
a plurality of indicators configured to indicate a status of each of the hard disks;
a first connector connected to the indicators; and
a second connector connected to a first part of the indicators.

2. The hard disk board of claim 1, wherein when the hard disk board operates, the first connector is electrically connected to the indicators, the second connector is not electrically connected to the first part of the indicators; the first connector transmits control signals from the at least one motherboard to the indicators, the indicators selectively enter in a first indicating state or a second indicating state based on the control signals; the first indicating state differs from the second indicating state; the first indicating state and the second indicating state represent different statuses of the hard disks.

3. The hard disk board of claim 2, wherein the indicators are light emitting diodes, an unlit state of each of the indicators is defined as the first indicating state, and a light state of each of the indicators is defined as the second state.

4. The hard disk board of claim 1, wherein when the hard disk board operates, the second connector is electrically connected to the first part of the indicators, the first connector is electrically connected to a second part of the indicators; the first connector and the second connector transmit control signals from the at least one motherboard to the first, second parts of the indicators, the first, second parts of the indicators selectively enter in a first indicating state or a second indicating state based on the control signals; the first indicating state differs the second indicating state; the first indicating state and the second indicating state represent different statuses of the hard disks.

5. The hard disk board of claim 4, wherein the indicators are light emitting diodes, an unlit state of each of the indicators is defined as the first indicating state, and a light state of each of the indicators is defined as the second state.

6. A server system, comprising:
at least one motherboard;
a plurality of hard disks connected to the at least one motherboard; and
a hard disk board connected between the at least one motherboard and the hard disks, the hard disk board comprising:
a plurality of indicators indicating a status of each of the hard disks;
a first connector connected to the indicators; and
a second connector connected to a first part of the indicators.

7. The server system of claim 6, wherein when the server system is powered on, the at least one motherboard is electrically connected to the hard disks and the first connector, the first connector is electrically connected to the indicators; the first connector transmits control signals from the at least one motherboard to the indicators, the indicators selectively enter in a first indicating state or a second indicating state based on the control signals; the first indicating state differs from the second indicating state; the first indicating state and the second indicating state represent different statuses of the hard disks.

8. The server system of claim 6, wherein when the server system is powered on, the at least one motherboard is electrically connected to the hard disks, the first connector, and the second connector, the second connector is electrically connected to the first part of the indicators, the first connector is electrically connected to a second part of the indicators; the first connector and the second connector transmit control signals from the at least one motherboard to the first, second parts of the indicators, the first, second parts of the indicators selectively enter in a first indicating state or a second indicating state based on the control signals; the first indicating state differs the second indicating state; the first indicating state and the second indicating state represent different statuses of the hard disks.

9. The server system of claim 8, wherein the indicators are light emitting diodes, an unlit state of each of the indicators is defined as the first indicating state, and a light state of each of the indicators is defined as the second state.

10. The server system of claim 6, further comprising a first median plate and a first cable, wherein the at least motherboard is connected to the hard disk board via the first median plate; the first median plate includes a third connector, a first decoder, and a first driver; the at least motherboard is connected to the third connector via the first decoder and the first driver in sequence; the third connector is further connected to the first connector via the first cable; the first decoder decodes the control signals from the at least motherboard; the first driver amplifies the decoded control signals, and outputs the amplified control signals to the indicators via the first connector.

11. The server system of claim 6, further comprising a first median plate, a second median plate, a first cable, and a second cable, wherein the at least motherboard comprises a first motherboard and a second motherboard; the first motherboard is connected to a first part of the hard disks and the first connector via the second median plate; the second motherboard is connected to a second part of the hard disks and the second connector via the second median plate; the first median plate includes a third connector, a first decoder, and a first driver; the first motherboard is connected to the third connector via the first decoder and the first driver in sequence; the third connector is further connected to the first connector via the first cable; the first decoder decodes first control signals from the first motherboard; the first driver amplifies the decoded first control signals, and outputs the amplified first control signals to the indicators indicating the status of each of the first part of the hard disks; the second median plate includes a fourth connector, a second decoder, and a second driver; the second motherboard is connected to the fourth connector via the second decoder and the second driver in sequence; the fourth connector is further connected to the second connector via the second cable; the second decoder decodes second control signals; the second driver amplifies the decoded second control signals from the second decoder, and outputs the amplified second control signals to the indicators indicating the status of each of the second part of the hard disks.
